(19) United States
(12) Patent Application Publication
(10) Pub. No.: US 2017/0270067 A1
(43) Pub. Date: Sep. 21, 2017

(54) USB HUB HOST DETECTION

(71) Applicant: Triad Seminconductor, Inc., Winston-Selam, NC (US)

(72) Inventors: Fei Hu, Cary, NC (US); Jeffrey D. Potts, Mocksville, NC (US)

(21) Appl. No.: 15/463,480

(22) Filed: Mar. 20, 2017

Related U.S. Application Data
(60) Provisional application No. 62/310,111, filed on Mar. 18, 2016.

(51) Int. Cl. G06F 13/366; G06F 13/40; G06F 13/42

(52) U.S. Cl. CPC G06F 13/366; G06F 13/4282; G06F 13/4068; G06F 2213/0042

(57) ABSTRACT

A USB hub capable of detecting a host connected to a port are disclosed. In an embodiment, a USB hub may include a first USB port, a second USB port, and a USB hub controller coupling the first USB port and the second USB port for data transmission between the first USB port and the second USB port. The USB hub controller may be configured to evaluate each USB port for a connection type. The USB hub controller may also be configured to identify an original host connected to the first USB port. The USB hub controller may also be configured to designate the first USB port as an upstream facing port for the purpose of USB communications. The USB hub controller may further be configured to designate the second USB port as a downstream facing port.

### CROSS-REFERENCE TO RELATED APPLICATIONS

This application claims the benefit of U.S. provisional patent application Ser. No. 62/310,111, filed on Mar. 18, 2016, entitled “USB Smart Host Detection,” the entire disclosure of which is incorporated herein by reference.

### TECHNICAL FIELD

The present disclosure generally relates to USB hubs, and more particularly relates to USB hubs capable of reconfiguring port assignments.

### BACKGROUND

In general, Universal Serial Bus (USB) hubs may allow a single master, or host, to communicate with one or more slaves, peripherals, or devices. Consistent with the USB specification set forth by the Universal Serial Bus Implementers Forum, a USB hub is generally defined as electronic hardware that contains only on “upstream facing” port that communicates with the host, and one or more “downstream facing” ports that communicate with devices. Conventionally, the ports of the USB hub are physically assigned. That is, one specific port of the USB hub may be the upstream facing port, such that any device connected to the upstream facing port may act as the host with regard to the USB hub. The remaining ports of the USB hub may be downstream facing ports, such that any device connected to a downstream facing port may act as a non-host (e.g., slave, peripheral, etc.) with regard to the USB hub. As such, the roles of the devices connected to the USB hub may generally be dictated by the physical port to which each device is connected.

### SUMMARY

According to an implementation, a USB hub may include a first USB port, a second USB port, and a USB hub controller coupling the first USB port and the second USB port for data transmission between the first USB port and the second USB port. The USB hub controller may be configured to evaluate each USB port for a connection type. The USB hub controller may also be configured to identify an original host connected to the first USB port. The USB hub controller may also be configured to designate the first USB port as an upstream facing port for the purpose of USB communications. The USB hub controller may also be configured to designate the second USB port as a downstream facing port.

One or more of the following features may be included. Evaluating each USB port for the connection type may include evaluating each USB port according to a predetermined sequence. The USB hub controller may also be configured to identify the original host connected to the first USB port based upon, at least in part, a termination of a connection at the first USB port. Designating the second USB port as a downstream facing port may include presenting a host type termination at the second USB port. Designating the second USB port as a downstream facing port may include configuring the second USB port as a non-data port. The USB hub may further include one or more additional USB ports. The USB hub controller may be further configured to designate each of the one or more additional USB ports as downstream facing ports based upon, at least in part, designating the first USB port as an upstream facing port for the purpose of USB communications.

The USB hub controller may be further configured to identify a host reconfiguration trigger. The USB hub controller may also be configured to issue a disconnect to all USB ports. The USB hub controller may be configured to evaluate each USB port for a connection type. The USB hub controller may also be configured to identify a new host connected to the second USB port. The USB hub controller may be configured to designate the second USB port as an upstream facing port for the purpose of USB communications. The USB hub controller may also be configured to designate the first USB port as a downstream facing port.

Identifying the reconfiguration trigger may include identifying a disconnection of the original host. Identifying the reconfiguration trigger may include identifying a triggering signal. Designating the first USB port as a downstream facing port may be based upon, at least in part, designating the second USB port as an upstream facing port.

According to another implementation, a method may include evaluating, by a USB controller, each of a first USB port and a second USB port for a connection type. The first USB port and the second USB port may be coupled to the USB controller for data transmission between the first USB port and the second USB port. The method may also include identifying, by the USB controller, an original host connected to the first USB port. The method may include designating, by the USB controller, the first USB port as an upstream facing port for the purpose of USB communications. The method may further include designating, by the USB controller, the second USB port as a downstream facing port.

One or more of the following features may be included. Evaluating each USB port for the connection type may include evaluating each USB port according to a predetermined sequence. The method may include identifying the original host connected to the first USB port based upon, at least in part, a termination of a connection at the first USB port. Designating the second USB port as a downstream facing port may include presenting a host type termination at the second USB port. Designating the second USB port as a downstream facing port may include configuring the second USB port as a non-data port. The method may also include designating one or more additional USB ports as downstream facing ports based upon, at least in part, designating the first USB port as an upstream facing port for the purpose of USB communications.

The method may also include identifying a reconfiguration trigger. The method may include issuing a disconnect to all USB ports. The method may include evaluating each USB port for a connection type. The method may also include identifying a new host connected to the second USB port. The method may include designating the second USB port as an upstream facing port for the purpose of USB communications. The method may further include designating the first USB port as a downstream facing port.

Identifying the reconfiguration trigger may include identifying a disconnection of the original port. Identifying the reconfiguration trigger may include identifying a triggering signal. Designating the first USB port as a downstream facing port may be based upon, at least in part, designating the second USB port as an upstream facing port.

According to another implementation, a computer program produce may reside on a non-transitory computer readable medium having a plurality of instructions stored on it. When executed by a processor, the instructions may cause the processor to perform operations including evaluating, by a USB controller, each of a first USB port and a second USB port for a connection type. The first USB port and the second USB port coupled to the USB controller for data transmission between the first USB port and the second USB port. Instructions may be included for identifying, by the USB controller, an original host connected to the first USB port. Instructions may be included for designating, by the USB controller, the first USB port as an upstream facing port for the purpose of USB communications. Instructions may also be included for designating, by the USB controller, the second USB port as a downstream facing port.

### BRIEF DESCRIPTION OF THE DRAWINGS

FIG. 1 diagrammatically depicts an illustrative embodiment of a USB hub, according to an example embodiment;

FIG. 2 is a flow chart of an illustrative method for host detection, according to an example embodiment; and

FIG. 3 is a flow chart of an illustrative embodiment for host detection, according to an example embodiment.

### DETAILED DESCRIPTION OF EXAMPLE EMBODIMENTS

In general, embodiments of the present disclosure may provide a USB hub that may be capable of determining to which port of the USB hub a host device is connected. For example, rather than having a specific physical port for connecting to a host, the USB hub may be capable of evaluating the devices connected to the various ports of the USB hub to determine which of the devices is configured as a host. The port to which the host device is connected may be designated, or configured, as an upstream facing port of the USB hub, regardless of the physical port on the USB hub that the device is connected to. The remaining ports of the USB hub may be designated, or configured, as downstream facing ports. In some such embodiments, the upstream facing and downstream facing operation of the ports may provide virtual port assignment rather than physical port assignment. That is, for example, rather than the upstream facing port being a single, pre-determined, physical port of the USB hub, whichever port is determined to have a host device connected to it may be designated, or configured, as an upstream facing port. In some embodiments, the USB hub may leverage the ability for virtual port assignments to facilitate role switching of devices connected to the USB hub. For example, a device originally connected to the USB hub as a host and a device originally connected to the USB hub as a non-host may switch roles. Upon determining that the devices have switched roles, the USB hub may be capable of switching port assignments, or configurations. As such, the port to which the new host is connected may be designated, or configured, as the upstream facing port, and the port to which the new non-host is connected may be designated, or configured, as a downstream facing port. Consistent with some implementations, the features and functionality of the USB hub may be achieved without requiring any special wiring hardware associated with connected devices (e.g., unique wiring hardware may not be required amongst devices participating in role switching or devices capable of assuming either/both a host and a non-host role).

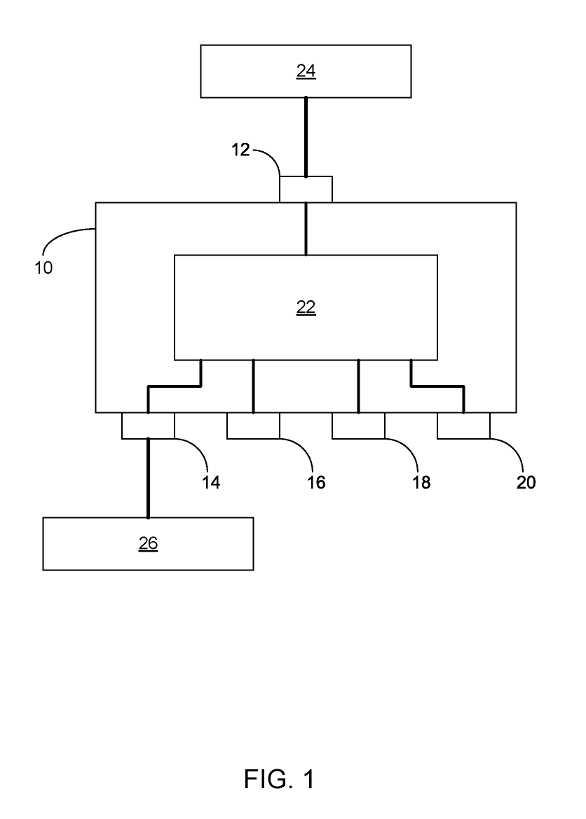

Referring to FIG. 1, an illustrative example of a USB hub consistent with the present disclosure is shown. As illustrated, the hub may include at least a first USB port 12 and a second USB port 14. In some implementations, the USB hub 10 may include one or more additional ports (e.g., ports 16, 18, 20). It will be appreciated that the depicted configuration of the USB hub 10 is intended for illustrative purpose only, and should not be construed as a limitation on the present disclosure. For example, the physical arrangement of the several ports (e.g., the physical location of the ports), as well as the number of ports may be varied depending on design considerations and need. The USB hub 10 may additionally include a USB hub controller 22. The USB hub controller 22 may generally couple the various ports (e.g., ports 12, 14, 16, 18, 20) of the USB hub 10 for data transmission between devices connected to the various ports of the USB hub 10. In addition to managing data communications amongst the various ports, the USB hub controller 22 may also generally be configured to detect the role (e.g., host or non-host) of the devices connected to the USB port 10. In the illustrated example two devices (e.g., device 24 and device 26) are depicted as being connected to the USB hub 10 through the first USB port 12 and the second USB port 14, respectively. While only two devices are shown connected to the USB hub 10, it will be appreciated that one or more additional device may also be connected to the USB hub 10 (e.g. through one or more of ports 16, 18, 20).

According to various embodiments, the USB hub controller 22 may be implemented in hardware, firmware, software, and/or any combinations of the above. For example, the USB hub controller may include application specific hardware (such as an application specific integrated circuit, field programmable gate array, or other application specific hardware configurations), general purpose hardware (e.g., which may implement firmware and/or software for the carrying out the operations of the USB hub controller), as well as various combinations thereof. Additional and/or alternative implementations for the USB controller 22 may also be utilized. Further, while the USB hub controller has been diagrammatically depicted as a single component, it will be appreciated that in various implementations, a USB hub controller may include multiple discrete and/or integrated (to various degrees) components. According to embodiments consistent with the present disclosure, the USB hub may include additional and/or alternative features and configurations, including, but not limited to, being an integrated component of another device or system.

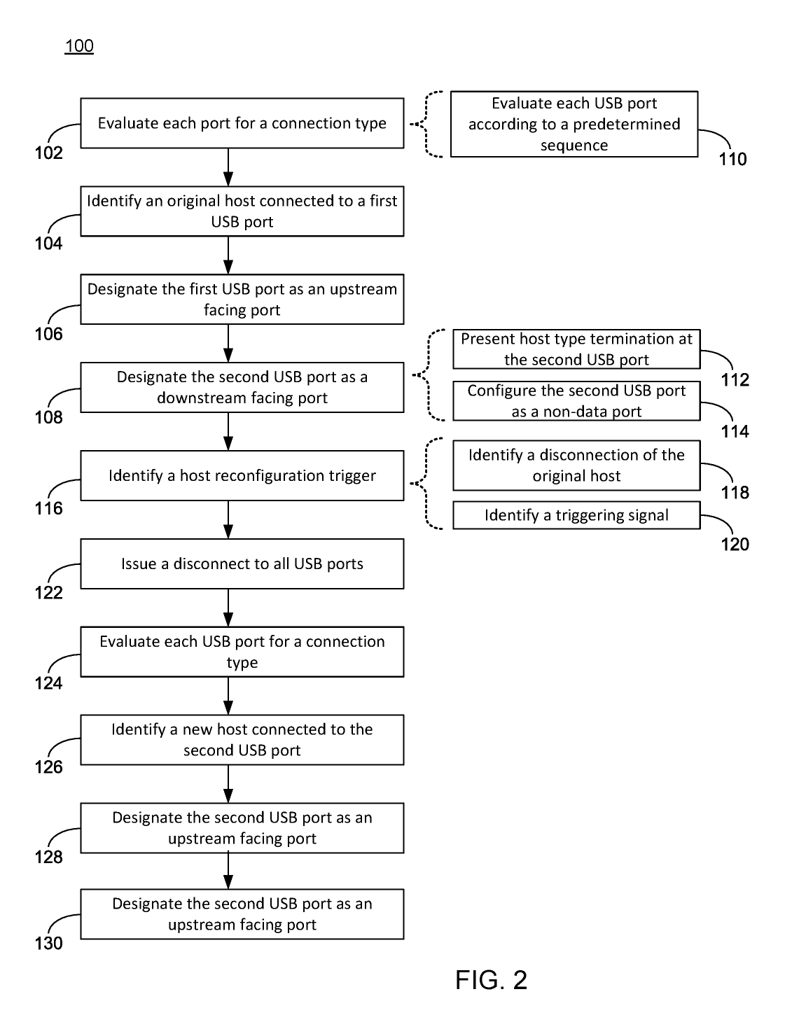

With additional reference to FIG. 2, the USB hub controller 22 may generally be configured to implement a port assignment process 100. In general, and consistent with the illustrated example embodiment, the USB hub controller 22 may be configured to evaluate 102 each USB port (e.g., at least each of the first USB port 12 and the second USB port 14) for a connection type. The USB hub controller 22 may also be configured to identify 104 an original host connected to the first USB port. The USB hub controller 22 may also be configured to designate 106 the first USB port as an upstream facing port for the purpose of USB communications. The USB hub controller 22 may further be configured to designate 108 the second USB port as a downstream facing port.

With continued reference to FIG. 2, the port assignment process 100, implemented by the USB hub controller 22, may include evaluating each USB port for a connection type. For example, on initial power up of the USB hub 10, or following a rest of the USB hub 10, the USB hub controller 22 may come out of reset, and may evaluate 102 each of the ports (e.g., including the first port 12 and the second port 14, however any additional ports associated with the USB hub 10 may also be evaluated) for a connection type. In this regard, the USB controller 22 may search for a host device connected to one of the ports. Evaluating 102 each of the USB ports for a connection type may include evaluating a termination presented by any/each device (e.g., devices 24, 26) connected to the USB hub 10. As is generally known, terminations presented on the serial data lines of a USB connected, or connectable, device may be implemented through the use of resistors tied to an appropriate voltage that meets the USB specification for a connection type or device role. Evaluating 102 each of the USB ports for a connection type may include evaluating the characteristics of the serial data lines (e.g., detecting the termination resistance) for each of the USB ports (e.g., of the respective devices connected to each USB port).

In an embodiment, evaluating 102 each port of the USB hub for a connection type may include evaluating 110 each USB port according to a predetermined sequence. Examples of predetermined sequence may include, for example, evaluating 110 each port according to a round robin scheme. Another example of a predetermined sequence may include, for example, evaluating each port according to a pre-established priority. For example, the ports may each include a sequential identifier, and evaluating 110 each port according to a predetermined sequence may include sequentially evaluating 110 each port based upon, at least in part, the sequence of the port identifiers. It will be appreciated that additional and/or alternative predetermined sequences may be utilized.

An original host connected to the first USB port may be identified 104. For example, and as generally mentioned above, the USB hub controller 22 may evaluate each port (e.g., ports 12, 14, 16, 18, 20) of the USB hub 10 to determine if a device connected to one of the ports presents a host termination, e.g., based upon, at least in part, a the resistance on the serial data lines of the USB connection for each port. An original host (e.g., device 24 in the illustrated example) may be identified 104 as being connected to the first USB port (e.g., port 12) of the USB hub 10 based upon, at least in part, a termination of a connection at the first USB port 12 being a host termination, e.g., as may be specified by the USB specification.

The first USB port (e.g., port 12) may be designated 106 and/or configured as an upstream facing port for the purpose of USB communications via the USB hub 10. As the upstream facing port, device 24 connected to the USB hub 10 via the first port 12 may assume the role as the host, relative to any other devices (e.g., device 26 connected to the second USB port 14) connected to the USB hub 10, for the purpose of interactions between devices connected to the USB hub 10. In an embodiment, designating 106 the first USB port as an upstream facing port may include enabling an upstream port device termination within the USB hub relative to the first USB port 12. Consistent with the foregoing example embodiment, designating 106 the first USB port 12 as an upstream facing port may be considered a virtual port assignment. That is, designating 106 the first USB port 12 as an upstream facing port may not be based upon a physical characteristic of the port and/or relationship of the port to the USB hub controller, but rather may be based upon identifying 104 an original host (e.g., device 24) connected to the first USB port 12. In some embodiments, if an original host is not identified, a default port (e.g., the first port) may be designated as the upstream facing port. In some embodiments, if an original host is not identified, the USB hub controller may reset, and, upon coming out of reset, reevaluate each port for a connection type to identify an original host. The reset may be based upon one or more predetermined time periods, such as an idle interval that may occur if an original host is not identified after a predetermined port evaluation period.

The second USB port 14 may be designated 108 and/or configured as a downstream facing port for the purpose of USB communications. In some embodiments, and in a similar manner as described with respect to designating 106 the first USB port as being an upstream facing port, designating 108 the second USB port 14 as a downstream facing port may be a virtual port assignment, e.g., in that the designation of the second USB port as a downstream facing port may not be based upon a physical characteristic of the port and/or a relationship of the port to the USB hub controller, but rather may be based upon a host termination not being identified for the second USB port.

In an embodiment, designating 108 the second USB port as a downstream facing port may include configuring the second USB port to present 112 a host type termination. For example, presenting 112 a host type termination at the second USB port may include setting a host type termination resistance (e.g., resistance on the serial data lines of the second USB port). As such, the second USB port may appear to be, and behave as, a USB host type device for any device connected to the second USB port 14 (e.g., device 26). Consistent with such a configuration, the USB hub 10 may allow for cascading USB hubs (e.g., as another hub connected to a downstream facing port may recognize USB hub 10 as a host device). Consistent with another implementation, designating 108 the second USB port as a downstream facing port may include configuring 114 the second USB port as a non-data port. For example, configuring 114 the second USB port as a non-data port may include configuring the second USB port 14 as a charging-only port.

As generally shown in the illustrative example, in some embodiments the USB hub may further include one or more additional USB ports (e.g., in addition to the first USB port 12 and the second USB port 14), such as USB ports 16, 18, and 20. As discussed above, the USB hub 10 may include a greater or fewer number of USB ports. In some embodiments, the USB hub controller 22 may designate, and/or configure, each of the one or more additional USB ports as downstream facing ports for the purpose of USB communications. In various example embodiments, designating the one or more additional USB ports as being downstream facing ports may be based upon, at least in part, designating the first USB port as an upstream facing port for the purpose of USB communications, and/or based upon, at least in part, identifying a non-host device as being connected to the one or more additional USB ports. In some implementations, the various downstream facing ports (e.g., ports 14, 16, 18, 20) may include the same configuration or may include different configurations. For example, each of the downstream facing ports may be configured to present a host type termination. In another example, each of the downstream facing ports may be configured as non-data ports. In a further example, a portion of the downstream facing ports may be configured to present a host type termination, and a portion of the downstream facing ports may be configured as non-data ports.

Once the first USB port 12 has been designated as the upstream facing port, and the second USB port 14 (as well as any additional ports that may be included) has been designated as a downstream facing port, the USB hub 10 may provide conventional USB hub functionality and operation. For example, the USB hub 10 may provide conventional USB functionality and operation with device 24 acting as the host, and with device 26 acting as the non-host.

In some implementations consistent with the present disclosure, in addition/as an alternative to initially identifying a host device connected to the USB hub at one of the USB ports, and designating that port as an upstream facing port, the USB hub may also be capable of accommodating reconfiguration of the ports such that a device connected to a downstream facing port may act as a host with respect to the USB hub and/or any devices connected to the USB hub. In an example, the USB hub may be capable of accommodating roles changes of one or more devices (e.g., from host to non-host and from non-host to host). In some embodiments, the role switch between the original host (e.g., device 24) and an original non-host (e.g., device 26) may occur though a negotiation between the original host (e.g., device 24) and the original non-host (e.g., device 26). In some embodiments, the USB hub 10 may not be party to such negotiations (e.g., other than, perhaps, in some embodiments, passing the communications concerning the negotiations between the original host and the original non-host). That is, the USB hub 10 need not be a participant in the role switching negotiations and/or need not have an awareness of the role switching negotiations. Further, while the role switching between the original host and the original non-host may arise through a role switching negotiation, in some embodiments the role switching may arise from other circumstances, and may not include a role switching negotiation between the original host and the original non-host. For example, one of the devices connected to the USB hub may issue a reconfiguration command. In a further example, a reconfiguration signal may be received, e.g., by an input from the USB hub (e.g., the USB hub may include a button or switch that may be actuated by a user to generate a reconfiguration signal) and/or an input from another device in communication with the USB hub.

Consistent with the foregoing, in an embodiment, the USB hub controller 22 may identify 116 a host reconfiguration trigger. In an embodiment, the identifying 116 the host reconfiguration trigger may include identifying 118 a disconnection of the original host. For example, in an example in which the original host device and the original non-host device may negotiate a role switch, the original host may disconnect from the USB hub 10. The disconnection of the original host may include a soft disconnect (e.g., as defined by the USB specification) and/or a hardware disconnect. Further, as discussed above, various other reconfiguration signals may be implemented. In such embodiments, identifying 116 a host reconfiguration trigger may include identifying 120 a triggering signal (e.g., generated from another device, resulting for user actuation of a reconfiguration button or switch, or another suitable triggering signal).

In response to identifying 116 a host reconfiguration trigger, the USB hub controller 22 may issue 122 a disconnect to all USB ports of the USB hub 10. In an embodiment, the disconnect issued 122 to all USB ports of the USB hub may include a soft disconnect (e.g., as defined by the USB specification). In some implementations, the disconnect of all USB ports of the USB hub 10 may release the port terminations of the USB hub 10, e.g., which may allow the USB hub controller 22 to detect termination resistance of any devices connected to any of the USB ports. In an embodiment, during the soft disconnect of all of the USB port, it may appear to devices connected to the USB hub as if there is no USB port connected.

The USB hub controller 22 may evaluate 124 the first USB port 12 and the second USB port 14 for a connection type. As noted above, evaluating 124 the USB ports for a connection type may include detecting a termination resistance associated with the serial data lines of any devices connected to the ports. In some implementations, only a portion of the USB ports of the USB hub may be evaluated (e.g., the first USB port 12 and the second USB port 14). In other implementations all of the USB ports of the USB hub may be evaluated to determine a connection type associated with any devices connected to each port. For example, in implementations in which the USB hub 10 includes one or more USB ports in addition to the first USB port 12 and the second USB port 14 (e.g., ports 16, 18, 20), each of the additional ports may also be evaluated for a connection type. In some implementation, only a subset of the included ports may be evaluated for a connection type. As noted above, evaluating 124 each port for a connection type may include evaluating each port to identify a host termination presented by the device connected to each respective port. In some embodiments, evaluating 124 each USB port for a connection type may include evaluating each USB port according to a predetermined sequence, e.g., as discussed in detail above.

In the context of a role switch between the original host (e.g., device 24) and the original non-host (e.g., device 26), in an illustrative example, during the disconnection period, each of the original host and the original non-host may reconfigure their respective termination type. As such, the original host (e.g., device 24) may reconfigure its termination type to be a non-host termination type, and the original non-host (e.g., device 26) may reconfigure its termination type to be a host termination type. Upon reconfiguring its termination type, the original non-host (e.g., device 26, now configured with a host termination type) may reconnect to the USB hub 10. Similarly, in an embodiment in which the original host is to communicate with other device connected to the USB hub 10, upon reconfiguring its termination type, the original host (e.g., device 24, now configured with a non-host termination type) may reconnect to the USB hub 10.

A new host may be identified 126 connected to the second USB port. For example, in the illustrated embodiment, device 26 may now be configured to present a host termination. When each port is evaluated 124 for a connection type, device 26, which is connected to the second USB port 14, may be identified as a new host based upon, at least in part, the presented host termination.

In response to identifying 126 the new host connected to the second USB port, the second USB port may be designated 128, and/or configured, the second USB port as an upstream facing port for the purpose of USB communications. In this regard, the second USB port 14 (i.e., the physical port), which was previously designated and/or configured as a downstream facing port may now be configured as the upstream facing port for the USB hub 10. Accordingly, the device 26 may now operate as the host with respect to any other devices connected to the USB hub 10. As generally discussed above, designating 128 the second USB port 14 as an upstream facing port may include USB hub controller 22 enabling upstream port device termination inside the USB hub 10 with respect to the second USB port 14. As also generally discussed above, designating 122 the second USB port 14 as an upstream facing port may be a virtual port assignment. For example, designating the second USB port 14 as an upstream facing port may not be based upon a physical characteristic of the second USB port 14 with respect to the USB hub, but rather may be based upon device 26, presenting a host termination, begin connected to the second USB port 14.

In response to the second USB port being designated 128 as the upstream facing port, the first USB port may be designated 130 as a downstream facing port. In this regard, the first USB port 12 (i.e., the physical port), which was previously designated and/or configured as the upstream facing port may now be configured as a downstream facing port for the USB hub 10. As generally discussed above, designating 124 the first USB port 12 as a downstream facing port may be a virtual port assignment. For example, designating the first USB port 12 as a downstream facing port may not be based upon a physical characteristic of the first USB port 12 with respect to the USB hub, but rather may be based upon, at least in part, the second USB port 14 being designated 122 as the upstream facing port. Additionally, an as also generally discussed above, designating 130 the first USB port as a downstream facing port may include configuring the first USB port to present a host type termination and/or may include configuring the first USB port as a non-data port. In implementations in which the USB hub includes one or more additional ports, the one or more additional ports may also be configured as downstream facing ports based upon, at least in part, designating 128 the second USB port as an upstream facing port. As also generally discussed above, all of the downstream facing ports may be configured to present a host type termination, all of the downstream facing ports may be configured as non-data port, or a portion of the downstream facing ports may be configured to present host type terminations and a portion of the downstream facing ports may be configured as non-data ports.

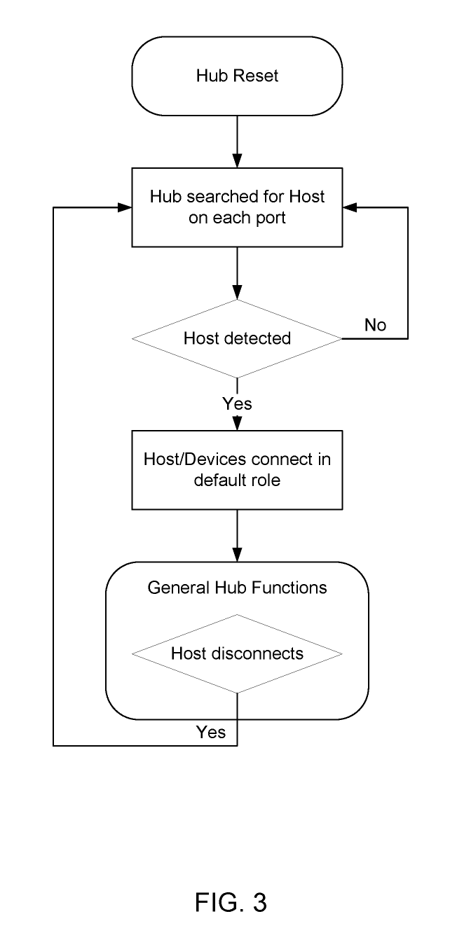

Referring also to FIG. 3, a specific illustrative example may be implemented in connection with a four port hub in an automobile. For example, Apple Inc.'s Mfi Accessory Interface Specification R18.pdf describes a method for an automotive head unit (car radio) to initiate CarPlay when a compatible Apple device is connected. In this specific illustrative example, the head unit may be connected to Port0 of the USB hub. At power up of the hub, (e.g., which may result from powering up of the head unit), the hub may search for a host. The head unit may initially be detected as a host device (e.g., based upon a termination presented by the head unit and/or based upon a default assignment). As such, the USB hub may assign the head unit at Port0 as being the upstream facing port, with the head unit operating in a host role. The remaining three ports of the USB hub (e.g., Port1, Port2, and Port3) may be designated as downstream facing ports, e.g., which may be configured to support slave device (e.g., such as peripherals, mass storage devices, and/or other devices operating in a non-host role). Accordingly, any devices connected to (at startup or at a later point) the Port1, Port2, or Port3 may be enumerated as non-host devices to the USB port.

In the illustrative embodiment, only Port0, Port1, and Port2 may be configured to support role switching, while Port3 may not. The host (in this example, the head unit connected to Port0) may send a request for role switching to a device connected to Port1 (e.g., a smartphone, such as an Apple iPhone). In an embodiment in which the device connected to Port1 supports role switching, the device may perform a soft disconnect from the USB hub, and may reconfigure the DP and DM as host terminations. The head unit, as the initial host, may also perform a soft disconnect from the USB hub and may reconfigure DP and DM as non-host terminations. The USB hub may detect the soft disconnect of the host at Port0. In response to detecting the disconnect of the host, the USB hub may reset and may enter host discovery mode. In host discovery mode, the USB hub may search for a host on each port. In this example, the USB hub may only search for a host on Port0 and Port1, and Port2, as these may be the only two ports configured for role switching.

If the new host is not discovered within the allowed time as defined by the USB specification, the hub may revert back to Port0 as the host. The device connected to Port1, acting as temporary host, may be discovered on Port1. Additionally/alternatively, as Port2 may also support role switching, a device configured as a host may also be discovered on Port2. The original upstream/host port, Port0, may become a downstream port (at least temporarily). In some embodiments, with a new host detected on Port1, all other ports may be disabled with regard to data and become dedicated charging ports. However, in other implementations, all of the remaining ports may remain enabled with regard to data.

In an embodiment, once the mission of the temporary host on Port1 is complete, the device connected to Port1 may perform either a soft disconnect or may be physically disconnected. In response to the temporary host being disconnected, the USB hub may detect the host disconnection, and may reset, and then re-enter host detection mode, whereby the USB hub may search for a host on each port.

It will be appreciated that the foregoing illustrative examples are intended only for the purpose of explanation. Accordingly, the concepts of the present disclosure may be more broadly applied to other embodiments. Further, as will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purpose of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A USB hub comprising:
a first USB port;
a second USB port; and
a USB hub controller coupling the first USB port and the second USB port for data transmission between the first USB port and the second USB port, the USB hub controller configured to:
evaluate each USB port for a connection type;
identify an original host connected to the first USB port;
designate the first USB port as an upstream facing port for the purpose of USB communications; and
designate the second USB port as a downstream facing port.

2. The USB hub according to claim 1, wherein evaluating each USB port for the connection type includes evaluating each USB port according to a predetermined sequence.

3. The USB hub according to claim 1, wherein the USB hub controller is configured to:
identify the original host connected to the first USB port based upon, at least in part, a termination of a connection at the first USB port.

4. The USB hub according to claim 1, wherein designating the second USB port as a downstream facing port includes presenting a host type termination at the second USB port.

5. The USB hub according to claim 1, wherein designating the second USB port as a downstream facing port includes configuring the second USB port as a non-data port.

6. The USB hub according to claim 1, further comprising one or more additional USB ports, and wherein the USB hub controller is further configured to designate each of the one or more additional USB ports as downstream facing ports based upon, at least in part, designating the first USB port as an upstream facing port for the purpose of USB communications.

7. The USB hub according to claim 1, wherein the USB hub controller is further configured to:
identify a host reconfiguration trigger;
issue a disconnect to all USB ports;
evaluate each USB port for a connection type;
identify a new host connected to the second USB port;
designate the second USB port as an upstream facing port for the purpose of USB communications; and
designate the first USB port as a downstream facing port.

8. The USB hub according to claim 7, wherein identifying the reconfiguration trigger includes identifying a disconnection of the original host.

9. The USB hub according to claim 7, wherein identifying the reconfiguration trigger includes identifying a triggering signal.

10. The USB hub according to claim 7, wherein designating the first USB port as a downstream facing port is based upon, at least in part, designating the second USB port as an upstream facing port.

11. A method comprising:
evaluating, by a USB controller, each of a first USB port and a second USB port for a connection type, the first USB port and the second USB port coupled to the USB controller for data transmission between the first USB port and the second USB port;
identifying, by the USB controller, an original host connected to the first USB port;
designating, by the USB controller, the first USB port as an upstream facing port for the purpose of USB communications; and
designating, by the USB controller, the second USB port as a downstream facing port.

12. The method according to claim 11, wherein evaluating each USB port for the connection type includes evaluating each USB port according to a predetermined sequence.

13. The method according to claim 11, further comprising:
identifying the original host connected to the first USB port based upon, at least in part, a termination of a connection at the first USB port.

14. The method according to claim 11, wherein designating the second USB port as a downstream facing port includes presenting a host type termination at the second USB port.

15. The method according to claim 11, wherein designating the second USB port as a downstream facing port includes configuring the second USB port as a non-data port.

16. The method according to claim 11, further comprising designating one or more additional USB ports as downstream facing ports based upon, at least in part, designating the first USB port as an upstream facing port for the purpose of USB communications.

17. The method according to claim 11, further comprising:
identifying a reconfiguration trigger;
issuing a disconnect to all USB ports;
evaluating each USB port for a connection type;
identifying a new host connected to the second USB port;
designating the second USB port as an upstream facing port for the purpose of USB communications; and
designating the first USB port as a downstream facing port.

8. The Method according to claim 17, wherein identifying the reconfiguration trigger includes identifying a disconnection of the original port.

19. The method according to claim 17, wherein identifying the reconfiguration trigger includes identifying a triggering signal.

20. The method according to claim 17, wherein designating the first USB port as a downstream facing port is based upon, at least in part, designating the second USB port as an upstream facing port.

21. A computer program product comprising a non-transitory computer readable medium having a plurality of instructions stored thereon, which, when executed by a processor, cause the processor to perform operations including:
evaluating, by a USB controller, each of a first USB port and a second USB port for a connection type, the first USB port and the second USB port coupled to the USB controller for data transmission between the first USB port and the second USB port;
identifying, by the USB controller, an original host connected to the first USB port;
designating, by the USB controller, the first USB port as an upstream facing port for the purpose of USB communications; and
designating, by the USB controller, the second USB port as a downstream facing port.
